(19) United States
(12) Patent Application Publication
(10) Pub. No.: US 2023/0309574 A1
(43) Pub. Date: Oct. 5, 2023

(54) Plant-based cheese composition and method of making

(71) Applicant: Vertage LLC, New York, NY (US)

(72) Inventor: Margo Asquith, Washington, DC (US)

(73) Assignee: Vertage LLC, New York, NY (US)

(21) Appl. No.: 17/713,626

(22) Filed: Apr. 5, 2022

(51) Int. Cl. A23C 20/02

(52) U.S. Cl. CPC A23C 20/025

(57) ABSTRACT

Animal-free cheesemaking leveraging mycelium fermentation and microbial bio-design techniques facilitate production of plant-based cheese that exhibits enhanced flavor and texture. In one embodiment, the plant-based cheese is mozzarella, and a manufacturing method begins by fermenting a first mixture of soaked cashews and aquafaba liquid to produce cultured cashews. The cultured cashews are then blended into a second mixture together with additional aquafaba liquid, water, and a pea protein derived from mycelium fermentation. A preferred pea protein is shiitake-fermented pea protein. The second mixture is agitated through several mixing cycles while being progressively heated to produce a liquid blend, which blend is then extruded into the cheese composition. A filling and pack out operation is then applied to the cheese composition to produce the finished product, typically in the form of a mozzarella chub.

### BACKGROUND

### Technical Field

This application relates generally to animal-free cheesemaking.

### Background of the Related Art

Cheesemaking is rooted in centuries of experimentation, innovation, tasting, and refinement. Cultures and fermentation have endured for hundreds of years as crucial techniques to mastering the mouth-watering cheeses enjoyed today.

Vegan cheese is a category of non-dairy, plant-based cheese analogues. Vegan cheeses range from soft fresh cheeses to aged and cultured hard grate-able cheeses like plant-based Parmesan. The defining characteristic of vegan cheese is the exclusion of all animal products. Typically, vegan cheese is made with components derived from vegetables, such as proteins, fats and milks (plant milks). It also can be made from seeds, such as sesame, sunflower, nuts (cashew, pine nut, peanuts, almond) and soybeans; other common ingredients are coconut oil, nutritional yeast, tapioca, rice, potatoes and spices. Food scientists typically use a blend of gums, protein, solids, and fats to create the mouthfeel and melt of dairy cheese because vegan cheeses made with nuts do not melt due to the solid base on which they are composed. Vegan cheeses are often not cultured or aged; instead, acidic ingredients are used for flavoring. Vegan cheese production typically begins with plant-based proteins or vegetable proteins derived from edible protein sources and their milk. The manufacturing process of fermentation is often used to replicate dairy cheese texture and flavor, although proteins in plant-based milk react differently to culturing agents and do not coagulate as traditional cheese does.

There remains a need in the art to provide for enhanced manufacturing techniques and methods that improve the physical characteristics and flavor of vegan cheese compositions such as described above.

### BRIEF SUMMARY

To this end, the subject matter herein provides for animal-free cheesemaking that leverages mycelium fermentation and microbial bio-design techniques for production of plant-based cheese that exhibits enhanced flavor and texture. In one embodiment, the plant-based cheese is mozzarella, and a manufacturing method begins by fermenting a first mixture of a protein source (such as raw cashews that have been soaked with water), aquafaba liquid and natural microbe cultures to produce cultured cashews. The cultured cashews are then blended into a second mixture together with additional aquafaba liquid, water, and a pea protein derived from mycelium fermentation. A preferred pea protein is shiitake-fermented pea protein. The second mixture is agitated through several mixing cycles while being progressively heated to produce a liquid blend, which blend is then extruded into the cheese composition. A filling and pack out operation is then applied to the cheese composition to produce the finished product, typically in the form of a mozzarella chub.

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 depicts a method of manufacturing a plant-based cheese product according to this disclosure; and

FIG. 2 depicts a representative implementation of the method, together with the relative proportions of the ingredients during the respective manufacturing steps.

### DETAILED DESCRIPTION

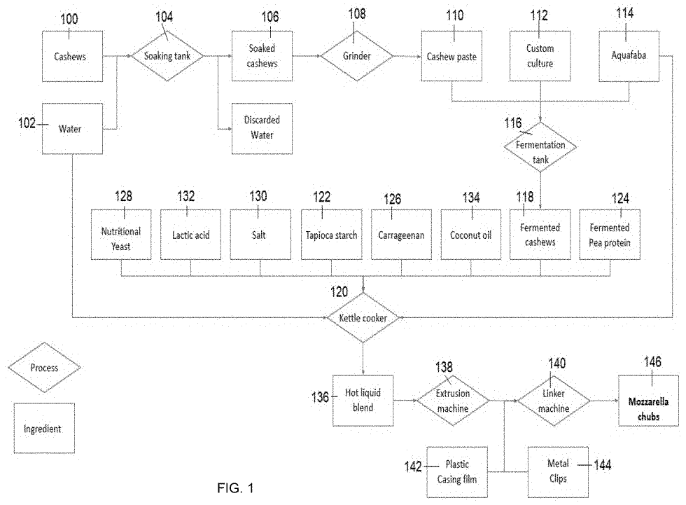

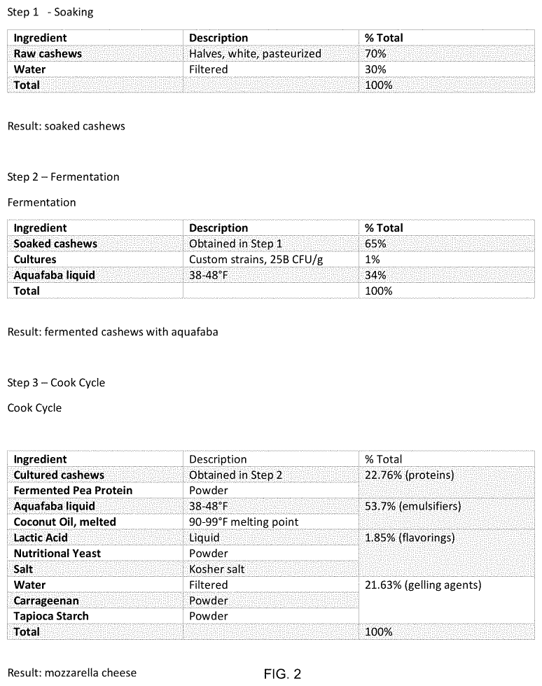

FIG. 1 depicts a representative manufacturing method for the plant-based mozzarella cheese composition of this disclosure. Preferably, and as will be described, the basic manufacturing process involves three (3) primary steps, namely, soaking, fermentation, and the cook cycle; fill and pack out operations are then used to produce the final product. FIG. 2 depicts the ingredients for each of the primary steps, together with the relative proportions with respect to each step. The % Total column identified for the cook cycle (Step (3) represent the relative proportions of the identified ingredient types of the final formed product.

In a preferred embodiment, the method begins at Step (1) (soaking) with cashews 100 and water 102 input to a soaking tank 104. As depicted, preferably the relative proportions are approximately 70% raw cashews, and the remainder filtered water. These relative proportions may vary. Soaked cashews 106 are output from the tank 104, with excess water 106 then discarded. Prior to fermentation, the soaked cashews 106 are applied through a grinder 108 to produce a cashew paste 110. For Step (2) (fermentation), the cashew paste 110, vegan cultures 112, and a legume-based liquid 114—preferably aquafaba liquid (38-48° F.)—are then combined in a fermentation tank 116, preferably with proportions of approximately 65% soaked cashews, approximately 1% cultures, and the remainder aquafaba liquid. These relative proportions may vary. The cultures are a blend of natural microbes that develop the desired cheese flavoring. Aquafaba (AQFB) is the viscous water in which legume seeds such as chickpeas have been cooked, and it has several desirable properties, i.e., foaming, emulsifying, binding and thickening. Fermented (cultured) cashews 118 output from the fermentation tank 116 from Step (2) are then further processed during the cook cycle Step (3) and at the identified relative proportions as follows.

Before a cook cycle is initiated, several mixing operations are carried out. First, the cultured cashews are supplied to a kettle cooker 120, together with the aquafaba liquid 114 and filtered water 102. As noted, these proportions are relative to the formed composition as a whole. These ingredients are mixed for a given time period measured in minutes to produce a mixture that is smooth and glassy. Thereafter, various additional ingredients are added, once again to arrive at the particular relative proportions for the finished product as identified in FIG. 2. As depicted, these additional ingredients include tapioca starch 122, a fermented pea protein powder 124, Kappa carrageenan powder 126, nutritional yeast powder 128, salt 130 (e.g., Kosher salt), lactic acid 132, and melted organic coconut oil 134. The aquafaba and coconut oil are emulsifiers. The cashew and pea protein are proteins. The lactic acid, nutritional yeast and salt are flavorings. The water, carrageenan and starch are gelling agents. FIG. 2 depicts the relative proportions of the ingredient types. In particular, and with respect to the final formed product, emulsifiers constitute approximately 53.7%, proteins constitute approximately 22.76%, flavorings constitute approximately 1.85%, and gelling agents constitute approximately 21.63%.

As depicted in FIG. 1, preferably, the tapioca starch 122, fermented pea protein 124, carrageenan 126, nutritional yeast 128, salt 130, together with a portion of the coconut oil 134, are mixed in initially and for a given time period measured in minutes; then, lactic acid 132 is added to the mixture and further mixing is carried out for another given time period measured in minutes. Thereafter, the remaining portion of the coconut oil is added to the mixture, and additional mixing is performed for another time period measuring in minutes. During the above-described mixing operations, preferably no heat is applied.

After mixing, a cook cycle is initiated. During the cook cycle, the kettle cooker provides shear mixing using agitation (paddles) at varying speed(s), and the cook temperature is gradually raised to approximately 190° F. over a time period. In a preferred implementation, when the heat is started, the cooker operates at a slow agitation (e.g., a % of top speed) for a firsts time period (measured in minutes); then, as the heat is raised, the cooker operates at a progressively higher agitation for a second time period (measured in minutes), and then a still higher agitation for a third time period (measured in minutes). Toward the end of the cook cycle, and after the temperature reaches its highest level, the cooker operates back at a slower agitation level until the cooking is completed. The cook cycle activates the starches and kills the cultures, producing a hot liquid blend 136. This blend is then processed by an extrusion machine 138 at a given temperature, e.g., above 170° F., to produce the result plant-based cheese product, which is gel-like in composition and that exhibits a medium soft texture. The filling and packing operations are conventional and use a linker machine 140 to fill the plant-based cheese material into a continuous plastic film casing 142, and to apply metal clips 144, thereby producing the final mozzarella chubs 146. Other packaging or form factors for the product may also be produced.

A preferred fermented pea protein is Fermentiq™ protein powder pea, which is available from Myco Technology. This ingredient is formed by an enzymatic process of fermenting pea protein with shiitake mushroom mycelium. The resulting fermented pea product is neutral in taste, light in color, exhibits good water and oil holding properties, is readily soluble, and is easily processed.

The use of aquafaba in both Steps 2 (fermentation) and 3 (the cook cycle) provides significant advantages. By inclusion during fermentation, the aquafaba facilitates the creation of a meringue-like protein starch fat matrix. It also provides a liquid base to facilitate the formation of the cultured cashews. By inclusion during cooking, the aquafaba acts as an emulsifier, ensures that the final cheese product has adequate moisture content, and the chickpea source provides for a desirable umami flavoring.

One of ordinary skill in the art will appreciate that ingredient substitutions (or supplementations) may be used. Thus, for example, for the cashews, other nuts or seeds (e.g., almond, peanut, sunflower, soy) may be used. Also, plant-based oils may be used, e.g., in place of (or to supplement) the coconut oil.

Although the above describes the manufacturing process in the context of a plant-based mozzarella cheese composition, the processing steps (soaking, fermentation and cooking/packing) may be used for other plant-based cheese compositions, such as cheddar cheese, cream cheese, crumble cheese, and the like. Thus, for example, a cheddar cheese product is manufactured using the same basic processing steps as described above, with the protein source preferably being oats in lieu of cashews. There may be additional variants in the additives. In this embodiment, representative ingredients for the cheddar cheese product include fermented oats (water, gluten free oat flour, vegan cultures), organic coconut oil, tapioca starch, nutritional yeast, Kappa carrageenan, apple cider vinegar, red miso, Baker's yeast, shiitake-fermented pea protein, xanthan gum, kosher salt, tomato powder, mustard powder, lactic acid, and annatto extract. In another embodiment, a cream cheese product is manufactured using the basic processing steps, and this product comprises the following ingredients: cashews, water, organic coconut oil, shiitake-fermented pea protein, kosher salt, and vegan cultures.

What I claim is as follows:

1. A method for manufacturing a plant-based cheese composition, comprising:
fermenting a first mixture of soaked cashews or oats, aquafaba liquid and natural microbe cultures to produce cultured cashews or oats;
blending into a second mixture the cultured cashews or oats, additional aquafaba liquid, water, and a pea protein derived from mycelium fermentation;
agitating while heating the second mixture to produce a liquid blend; and
extruding the liquid blend into the cheese composition.

2. The method as described in claim 1 further including packing the cheese composition into flexible packaging material.

3. The method as described in claim 1 wherein the soaked cashews or oats are produced by soaking raw cashews or oats in filtered water.

4. The method as described in claim 1 wherein the pea protein derived from mycelium fermentation is shiitake-fermented pea protein.

5. The method as described in claim 4 further including pre-blending the shiitake-fermented pea protein with an emulsifier, one or more flavoring agents, and one or more gelling agents.

6. The method as described in claim 1 wherein the second mixture is blended without heat.

7. The method as described in claim 1 wherein selectively agitating while heating includes heating the second mixture up to a temperature of 190° F.

8. The method as described in claim 7 wherein the liquid blend is extruded at a temperature that exceeds approximately 170° F.

9. The method as described in claim 1 wherein the cheese composition is one of: a mozzarella cheese chub, and a cheddar cheese.

10. A cheese product formed by ordered processing steps comprising:
fermenting a first mixture of soaked cashews or oats, aquafaba liquid and natural microbe cultures to produce cultured cashews or oats;
blending into a second mixture the cultured cashews oats, additional aquafaba liquid, water, and an admixture comprising pea protein derived from mycelium fermentation;
cooking the second mixture to produce a liquid blend;
extruding the liquid blend into a cheese composition; and
applying a filling and pack out operation to the cheese composition.

11. The cheese product as described in claim 10 wherein the ordered processing steps further include:
producing the soaked cashews or oats by soaking raw cashews or oats in filtered water.

12. The cheese product as described in claim 10 wherein the ordered processing steps further include:
producing the admixture by blending the pea protein derived from mycelium fermentation with one or more additives, the one or more additives being an emulsifier, a gelling agent, a flavoring agent, and combinations thereof.

13. A plant-based mozzarella cheese composition, comprising:
a protein source comprising cashews or oats, and a pea protein derived from mycelium fermentation;
an emulsifier comprising aquafaba;
one or more flavorings; and
one or more gelling agents.

14. The cheese composition as described in claim 13 wherein the protein source constitutes approximately 22.76%, the emulsifier constitutes approximately 53.7%, the one or more flavorings constitute approximately 1.5%, and the one or more gelling agents constitute approximately 21.63%.

15. The cheese composition as described in claim 13 wherein the emulsifier includes an oil.

16. The cheese composition as described in claim 13 wherein the one or more flavorings are one of: lactic acid, nutritional yeast, salt, and combinations thereof.

17. The cheese composition as described in claim 13 wherein the one or more gelling agents are one of: water, carrageenan, starch, and combinations thereof.
